(19) United States
(12) Patent Application Publication
(10) Pub. No.: US 2012/0063743 A1
(43) Pub. Date: Mar. 15, 2012

(54) SYSTEM AND METHOD FOR REMOTE PRESENTATION PROVISION

(75) Inventors: Vince G. Bratton, Las Vegas, NV (US); Casey C. Corcoran, Wake Forest, NC (US); Bradley M. Lea, Henderson, NV (US); Keith M. Levenson, Las Vegas, NV (US); Jason C. Straub, Henderson, NV (US)

(73) Assignee: LIGHTSPEED VT LLC, Las Vegas, NV (US)

(21) Appl. No.: 13/208,097

(22) Filed: Aug. 11, 2011

Related U.S. Application Data
(63) Continuation-in-part of application No. 13/206,952, filed on Aug. 10, 2011.
Application No. 13/206,952 is a continuation of application No. PCT/US2011/024578, filed on Feb. 11, 2011.
(60) Provisional application No. 61/303,903, filed on Feb. 12, 2010.

(51) Int. Cl. H04N 9/80

(52) U.S. Cl. 386/248; 386/E09.011

(57) ABSTRACT

A method of receiving and playing a composite video, wherein the composite video includes at least a video asset and a non-video asset in separate files. The method comprising: receiving the non-video asset; receiving at least a portion of the video asset; buffering the at least a portion of the video asset in a buffer; delaying playback of the composite video until (a) the non-video asset is downloaded and (b) the at least a portion of the video asset received is sufficient under existing conditions that the video asset can be played in real time without emptying the buffer before the end of the video asset; and playing, after the delaying, the composite video.

### CROSS REFERENCE TO RELATED APPLICATIONS

The instant application claims priority to, and is a continuation-in-part of, U.S. patent application Ser. No. 13/206,952 filed Aug. 10, 2011 entitled SYSTEM AND METHOD FOR REMOTE PRESENTATION PROVISION, which itself is a continuation of PCT/US2011/024578 filed Feb. 11, 2011 entitled SYSTEM AND METHOD FOR REMOTE PRESENTATION PROVISION, which itself claims priority to U.S. Provisional Patent Application 61/303,903 filed Feb. 12, 2010, the contents of which are incorporated herein by reference in its entirety.

### BACKGROUND OF THE INVENTION

1. Field of the Invention

The present invention generally relates to a system and method for remote presentation provisioning, such as a system and method for providing virtual training via a communications network. More specifically, the present invention relates to video, audio and/or text communication that is preferably presented in a substantially seamless interactive manner, and measures content use and/or content comprehension.

2. Discussion of Background Information

The distribution of content from a source to a recipient over the Internet or Intranet presents a variety of challenges. This is particularly so when the content includes video, as the size of the video file taxes the available bandwidths of the communication network and the processing speed of the client-side device on which it plays.

One method of video distribution is via download, in which the entire file is sent to the client-side device such that the video playback commences once the entire file is downloaded. A drawback of this method is that delivery of video files are quite large and can require a considerable period of time to download. Viewers often have short attention spans and may not wait for the amount of time required for the download process to complete.

Buffering involves sending the video file to the client-side device for buffering a portion of the video. Playback commences once the portion of the video is buffered. A drawback of this method, if not implemented effectively, is that if the rate of data playback exceeds the rate of data delivery, the video will be played from the buffer at a rate faster than the rate that the buffer is being filled with the download of the video. When the buffer is exhausted (all video in the buffer has been played), the video image will freeze (playback is stopped) while the buffer refills. This phenomenon, known as stutter, is distracting for the viewer and is overall detrimental to the viewing experience. Consequently, upon experiencing stutter, users will often lose concentration on the video and/or will turn it off completely.

Various methods are known to reduce stutter. For example, the amount of video data is related to the quality of the video file. The amount of video data can be reduced if the size of the client-side viewing screen is smaller, the image resolution is reduced, and/or the frame rate is reduced. The reduction in the amount of data being transmitted results in a corresponding improvement in the rate of delivery of video content. This improves the probability that the rate of delivery of the file will exceed the rate of video playback and potentially avoid stutter. The drawbacks of such methods are that the video image is undesirably smaller, less clear and/or less smooth.

It is often desirable to associate a video with other associated information. For example, for a recorded interview, it may be desirable to add a text caption below the interviewee that shows the name of the interviewee. The ability to add such information directly into video is well known, such as through IMovie and similar programs.

Such methods for associating information with video have several drawbacks. For example, the information is incorporated directly into the video. Should a change to the information be desirable, someone with video editing skills must implement the changes and essentially create a new video. There is no way to change the information without changing the video.

### SUMMARY OF THE INVENTION

According to an embodiment of the invention, a method of receiving and playing a composite video, wherein the composite video includes at least a video asset and a non-video asset in separate files. The method comprising: receiving the non-video asset; receiving at least a portion of the video asset; buffering the at least a portion of the video asset in a buffer; delaying playback of the composite video until (a) the non-video asset is downloaded and (b) the at least a portion of the video asset received is sufficient under existing conditions that the video asset can be played in real time without emptying the buffer before the end of the video asset; and playing, after the delaying, the composite video.

The above embodiment may have various optional features. These include displaying, during the delaying playback, a download progress bar, the progress bar representing the following equation:

Progress=(x·amount of non-video asset download)+(y·amount start video asset downloaded)

where:
x and y are predetermined values for which x+y=100%; and
“start video asset” is a portion of the video asset that, under existing conditions, needs to be downloaded before the video asset can be played in real time without emptying the buffer before the end of the video asset.

In the above steps, x may be 20% and y may be 80%. The existing conditions include at least the download rate, the length of the video asset, and the amount of time it will take to download the entire video asset. The video and non-video assets may be synchronized, and the composite video may include portions of the non-video asset displayed during discrete portions of playback of the video asset. The method may include receiving instructions for when to play discrete portions of the non-video asset relative to the video asset. The instructions may be part of the same file as the video asset. The non-video asset may include an image of a background on which the video asset will be displayed. The non-video asset may include text that will appear during a predetermined portion of the playing of the video asset. The non-video asset may include at least one test question, the method further comprising displaying the test question after playback of the video asset ends.

According to another embodiment of the invention, a method of playing a composite video is provided. The method includes: downloading a non-video asset file, the non-video asset file including a library of non-video assets; receiving a video; buffering the video; receiving instructions that (a) select the non-video asset from the library, (b) identify where in a display the non-video asset is to be displayed, and (c) when, relative to the video, the non-video asset is to be displayed; and playing the video and the selected non-video assets from the library, synchronized according to the instructions.

### BRIEF DESCRIPTION OF THE DRAWINGS

The present invention is further described in the detailed description, which follows, in reference to the noted plurality of drawings by way of non-limiting examples of certain embodiments of the present invention, in which like numerals represent like elements throughout the several views of the drawings, and wherein:

FIG. 1 illustrates a block diagrammatic representation of a system according to certain embodiments of the present invention;

FIGS. 2A-2D are views of different webpages displaying a composite video according to certain embodiments of the present invention;

FIG. 3 illustrates a view of a timeline according to certain embodiments of the present invention;

FIG. 4 illustrates a block diagrammatic view of delivery of a composite video presentation according to certain embodiments of the present invention;

FIG. 5 illustrates a block diagrammatic view of a process according to certain embodiments of the present invention;

FIG. 6 illustrates a block diagrammatic view of a process according to certain embodiments of the present invention;

FIG. 7 illustrates a block diagrammatic view of a process according to certain embodiments of the present invention;

FIGS. 8A-8E show screen shots of a composite video according to certain embodiments of the invention;

FIG. 9 shows a partial screen shot of a database of activity according to certain embodiments of the invention;

FIGS. 10A-10E show screen shots of a composite video according to certain embodiments of the invention;

FIGS. 11A-11D show screen shots of a creation tool according to certain embodiments of the invention.

FIG. 12 illustrates software code for downloading video according to certain embodiments of the invention.

### DETAILED DESCRIPTION OF EMBODIMENTS OF THE INVENTION

It is to be understood that the figures and descriptions of embodiments of the present invention have been simplified to illustrate elements/steps relevant for a clear understanding of the present invention, while eliminating, for the purpose of clarity, other elements/steps found or used in typical presentations, productions, data delivery, computing systems, devices and processes. Those of ordinary skill in the art may recognize that other elements and/or steps are desirable and/or required in implementing embodiments of the present invention. However, because such elements and steps are well known in the art, and do not facilitate a better understanding of the present invention, a discussion of such elements/steps is not provided herein.

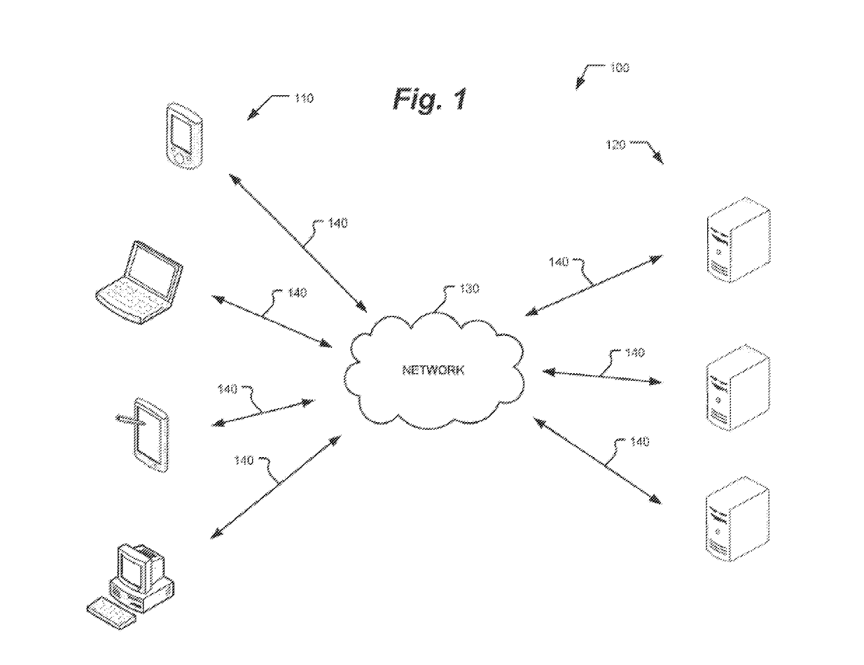

Referring now to FIG. 1, there is shown a configuration of a system 100 according to an embodiment of the present invention. In certain embodiments of the present invention, system 100 is well suited for performing and/or providing functionalities described herein.

System 100 generally includes a first class of computing devices 110 and a second class of computing devices 120. The groups may, but need not be mutually exclusive. For example, one or more computing devices may be members of more that one of classes 110, 120. Generally, each of the computing devices of classes 110, 120 are communicatively interconnected with one another via at least one data compatible network 130, such as the global interconnection of computers and computer networks commonly referred to as the Internet, and/or other wireline and/or wireless telecommunications networks. In the illustrated embodiment of FIG. 1, the computing devices of class 110 are interconnected with the computing devices of class 120 via network 130 and network connections 140. In certain embodiments of the present invention, one or more of these computing device interconnections may take the form of wireline and/or wireless Internet or other data network connections.

In certain embodiments of the present invention, class 110 computing devices may generally take the form of end-user computing devices, such as personal computers, like desktop, laptop and/or tablet computers, terminals, web-enabled personal digital assistants, Internet appliances and/or web enabled cellular telephones or smart phones, for example.

In certain embodiments of the present invention, class 120 computing devices may generally take the form of servers, for example. In certain embodiments of the present invention, class 120 computing devices may correspond to network or system servers. In certain embodiments of the present invention, computing devices in class 120 provide one or more websites that are accessible by computing devices in class 110, for example.

By way of non-limiting explanation, “computing device”, as used herein, generally refers to a general-purpose computing device that includes a processor. A processor, such as a microprocessor, as used herein, generally includes a Central Processing Unit (CPU). A CPU generally includes an arithmetic logic unit (ALU), which performs arithmetic and logical operations, and a control unit, which extracts instructions (e.g., code) from a computer readable medium, such as a tangible memory, and decodes and executes them, calling on the ALU when necessary. “Memory”, as used herein, generally refers to one or more devices or media capable of storing data, such as in the form of chips or drives. For example, memory may take the form of one or more random-access memory (RAM), read-only memory (ROM), programmable read-only memory (PROM), erasable programmable read-only memory (EPROM), or electrically erasable programmable read-only memory (EEPROM) chips, by way of further non-limiting example only. Memory may be internal or external to an integrated unit including the processor. Memory may take the form of magnetic or optical technology based storage media. Memory may be internal or external to a computing device. Memory may store a computer program, e.g., code or a sequence of instructions being operable by the processor. In certain embodiments of the present invention, one or more elements may take the form of, or functionalities discussed may be provided using, code being executed using one or more computing devices, such as in the form of computing device executable programs or applications being stored in memory There are various types of computing devices, having varying processing and memory capabilities, such as: personal computers (like those that are commercially available from Dell and Apple Corp.), and personal digital assistants and smart phones (like those that are commercially available from Apple Corp., Motorola, HTC and Research in Motion), by way of non-limiting example only.

A “server”, as used herein, is generally communicatively coupled to a network, and manages network resources. A server may refer to a discrete computing device, or may refer to an application that is managing resources rather than a discrete computing device. “Network”, as used herein, generally refers to a group of two or more computing devices communicatively connected to one-another. “Website”, as used herein, generally refers to a collection of one or more electronic documents (e.g., webpages) that are available via a computer and/or data compatible network, such as the Internet. By way of non-limiting example, a website may typically be accessed at a given address on the World Wide Web (e.g., “www.URL.TLD”), and include a home page, which is the first webpage visitors typically see when they enter the site. A website may also contain additional webpages. Webpages may be fixed, and/or dynamically generated in response to website visitor webpage requests. By way of further non-limiting example only, the World Wide Web is a system of Internet servers that generally support HTML (Hypertext Markup Language), such that a website visitor can jump from one webpage to another webpage by clicking on references to other webpages, such as hot spots or hot links (sometimes referred to as “links”). Web browsing applications, such as Microsoft's Internet Explorer, Google's Chrome, and Apple's Safari are commercially available applications typically used to access websites on the World Wide Web. Webpages are typically served by servers. Other computer network types and/or protocols and/or mark up languages and/or applications may be used.

Web browser applications, as referred to herein, may include one or more plug-ins. A plug-in, or add-on, as used herein, is a computer program (e.g., code stored in memory) that interacts with a host application (such as the web browser application) to provide a certain, often specific, function “on demand”. For example, a plug-in may be used to provide for media file playback within or in association with a host web browser application responsively to certain activity that occurs in connection with the host web browser application, e.g., a user clicking on a link,.

Certain embodiments of the present invention may be used to provide for virtual training By way of non-limiting example, virtual training may be used to teach general or specific knowledge, skills, and/or competencies in a simulated virtual environment. For example, virtual training can be used to provide one or more users with rich content, and/or video presentations via one or more webpages. In certain embodiments, these presentations may be interactive in nature, such that user interaction with the webpage or video presentation alters the course of presentation of the composite video presentations, akin to a “choose your own adventure”—type storyline. For example, user responses to inquiries presented via a video presentation or associated webpage (and/or a lack thereof) may be used to determine which presentation should be played next as part of the virtual learning or even a virtual testing environment and/or process.

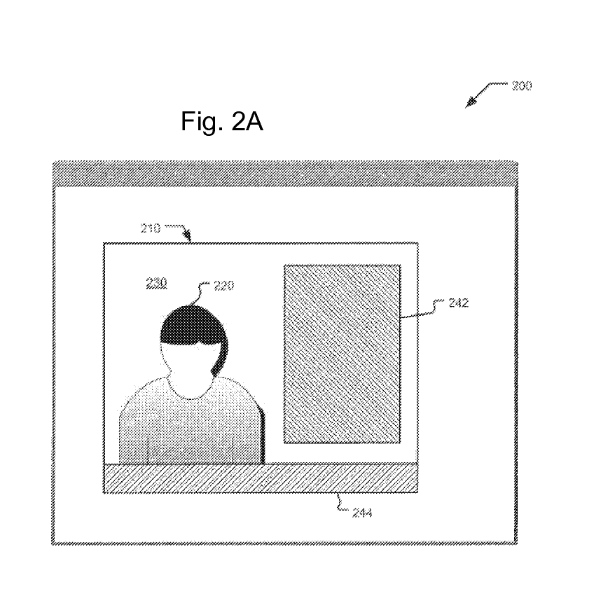

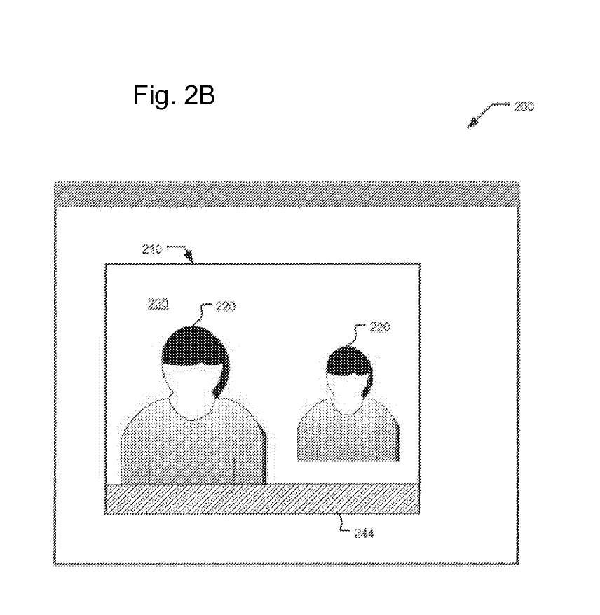

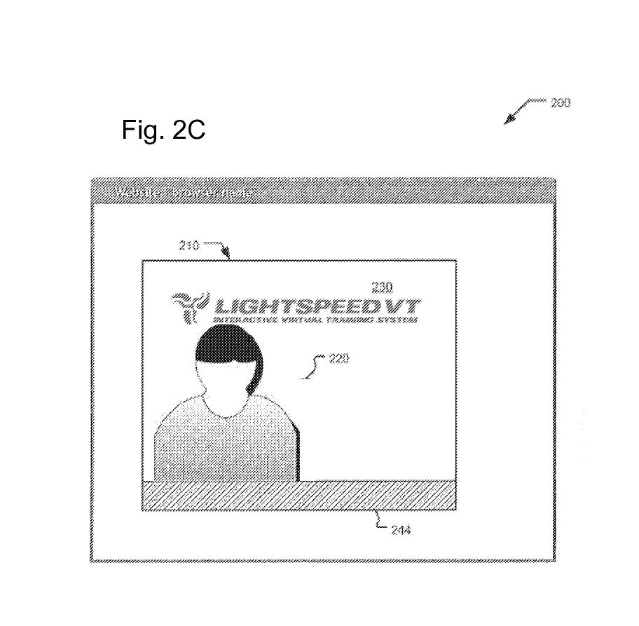

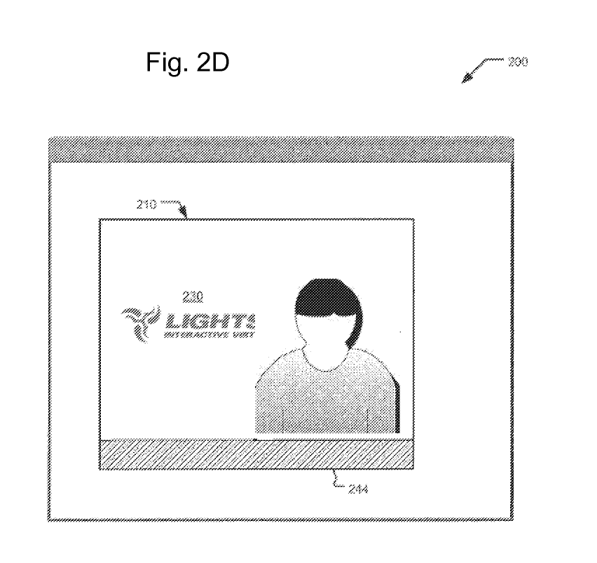

Referring now to FIG. 2A, there is shown an embodiment of a webpage 200 according to an embodiment of the invention. The webpage 200 may include one or more video presentations 210. The one or more presentations 210 may each take the form of a composite video presentation. In the illustrated embodiment of FIG. 2, video presentation 210 includes a video component or asset 220, a background component or asset 230 and two auxiliary or support components or assets 242, 244.

Although FIG. 2A only shows a specific number of each asset, any number of that type of asset can be present, such as shown in FIG. 2B (which shows two separate assets 220, but no asset 242). Additional assets of different types can also be present. For ease of reference, discussion will be limited to one of each asset 220, 230, 242 and 244, although the invention is not so limited.

Asset 220 generally takes the form of a digital audio/visual component (e.g., a digitized or digitally captured audio/video component in the form of a video file or data). Asset 230 generally takes the form of a background graphic component (e.g., an image file or data). The graphic of asset 230 may be static or dynamic in nature (e.g., a static or dynamic image file or data). Assets 242, 244 may take the form of auxiliary components, such as text and/or image components (e.g., text and/or an image files or data). When the present invention is combined in accordance with a timeline, such assets may provide a composite video presentation that provides for a rich virtual communication environment, such as for training or learning.

By way of non-limiting example, asset 220 may be a video of an individual speaker. Preferably, asset 220 was created by filming in an environment that includes the individual speaker but lacks any filmed background, such as via a green screen. In the embodiment of FIG. 2A, asset 230 is preferably a backdrop for the asset 220. By way of non-limiting example, asset 230 could be a picture that sets the backdrop on which asset 220 appears. FIG. 2C is a non-limiting example of a screen shot of asset 220 in the form of an individual with backdrop asset 230 in the form of a corporate logo. Although the logo is shown above asset 220, it could be in any position relative to the asset 220, such as behind the asset such as shown in FIG. 2D.

Using prior art techniques, the speaker would have been filmed standing in front of the backdrop. The result would have been a single video file of considerable size, with all of the drawbacks discussed above. In contrast, video asset 220 populates only a small fraction of area 210, and per its smaller physical size, requires a relatively smaller data file. An image file as asset 230 typically requires a larger viewing size, but as it known in the art, the amount of data for a static image is far less than the amount of data for a video. Collectively, the amount of data needed to produce a composite video of video asset 220 and image asset 210 is only a small portion of the amount of data needed to produce a composite video of the prior art. Since less overall data is ultimately sent to the client-side device, the resulting composite video therefore minimizes, if not completely avoids, stutter or reduction in video quality. To the contrary, it is possible to use higher resolution video for the video asset 220, thus providing a richer content experience for the user.

In the alternative, video asset 220 could be a video that fills the entire area shown generally at 230. In this example, video asset 220 could be a full-filmed video and/or components filmed using a green screen to which a backdrop was added in video production and is part of the video asset 220. Asset 230 may be unnecessary in such an environment, although it could potential be used elsewhere in the display for various purposes.

As discussed in more detail below, each video asset 220 is preferably a separate date file from assets 230, 242 and 244. Assets 230, 242 and/or 244 may themselves be different data files, all one file, or some hybrid thereof. For FIG. 2A, the client-side device will receive the files and visually layer them consistent with video recombination instructions (discussed in more detail below). In FIG. 2A, assets 220, 242 and 244 are layered to appear in front of asset 230. Video files are preferably FLASH Video files (fly), but other file formats may be used, such as MP4 formats. Assets 230, 242 and/or 244 are preferably ShockWave FLASH files (swf) files, although other file formats may be used.

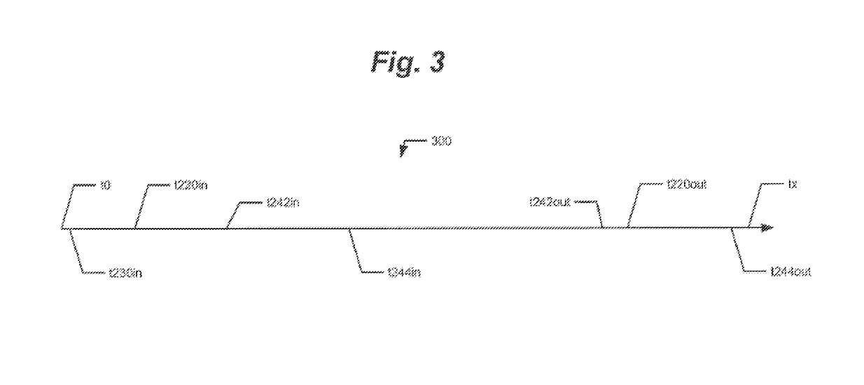

The use of separate files for the various assets provides a variety of advantages. Assets 220, 230, 242, 244 may be presented in varying positions, sizes and times to form and present a composite video presentation. For example, and referring now to FIG. 3, there is shown an exemplary timeline 300 that may correspond to the presentation of assets 220, 230, 242, 244 to a user as part of a video presentation via a webpage. In the illustrated embodiment of FIG. 3, the composite video presentation begins at time t0 and ends at time tx. Asset 230 is presented beginning at time t230in and ending at time tx. Asset 242 is presented beginning at time t242in and ending at time t242out. Asset 220 is presented beginning at time t220in and ending at time t220out. Asset 244 is presented beginning at time t244in and ending at time t244out. The exemplary timeline of FIG. 3 is by way of non-limiting example only.

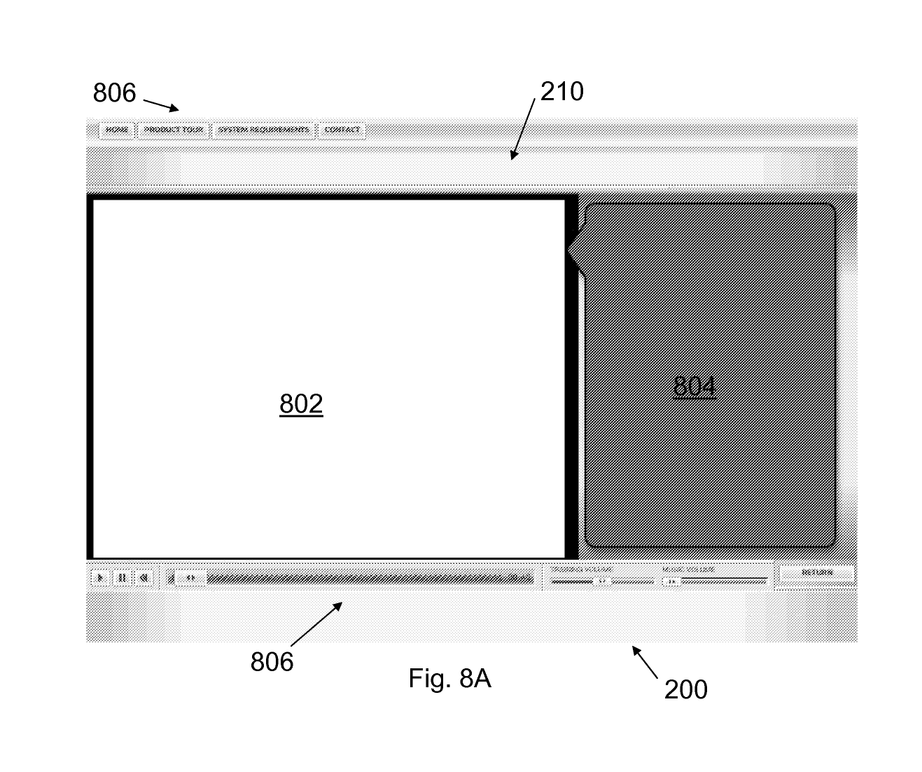

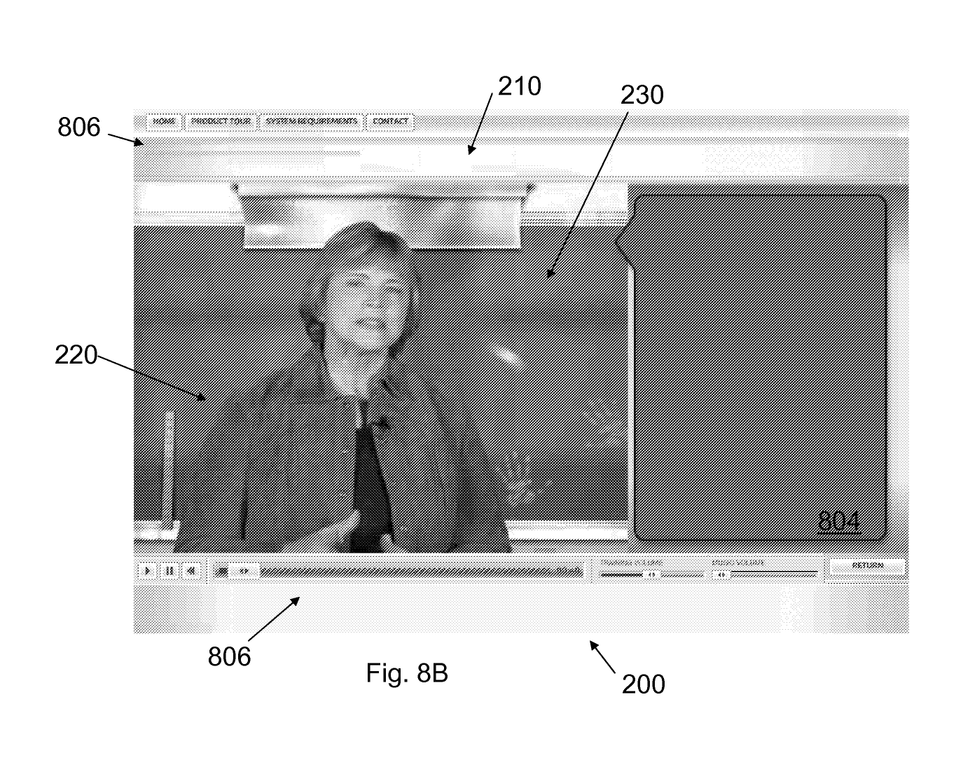

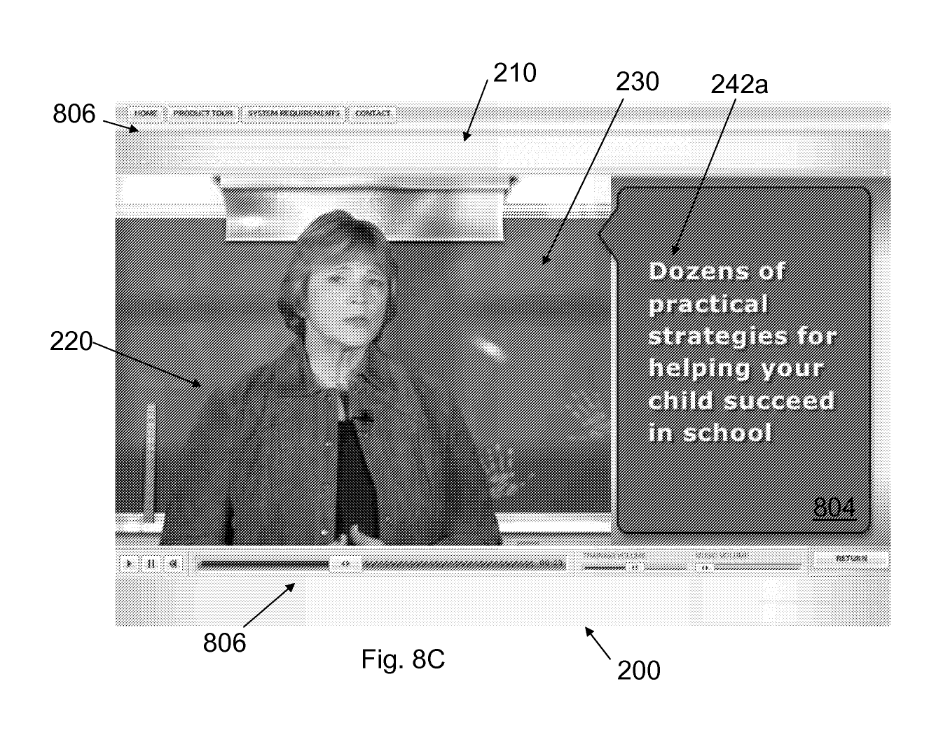

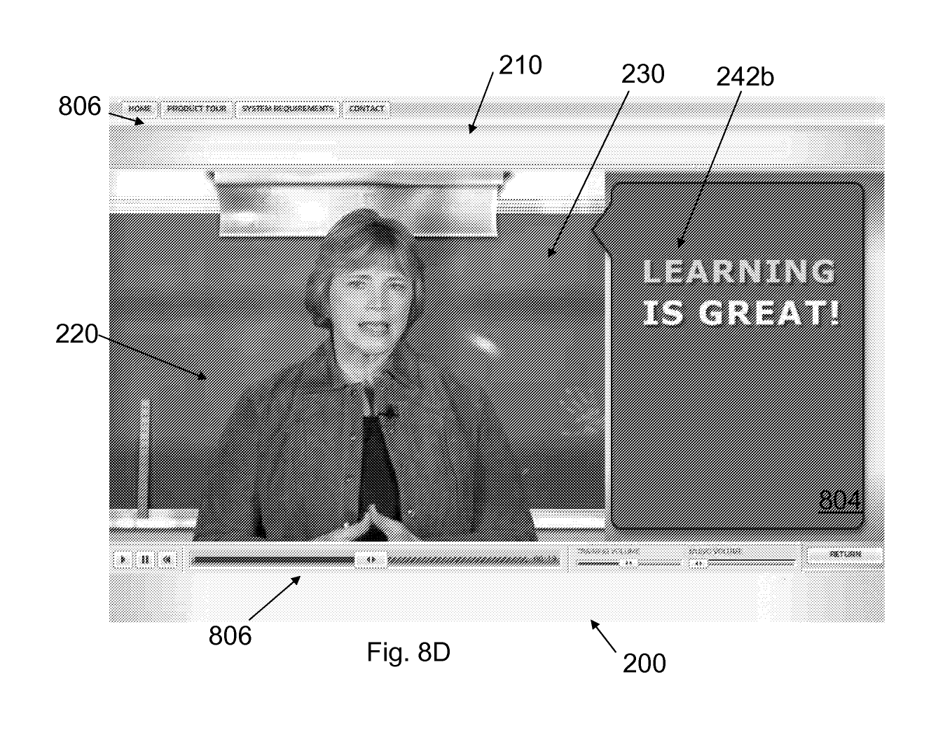

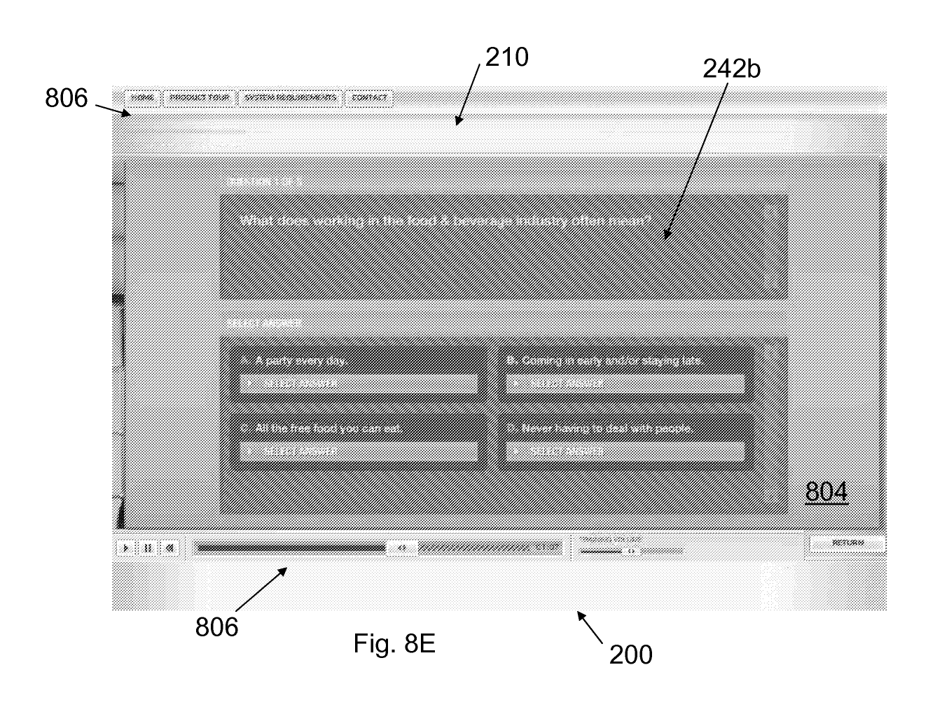

By way of another example, consider the screenshots in FIGS. 8A-8E. Referring now to FIG. 8A, the system provides an environment 800 for presenting the composite video. Area 802 provides space for assets 220 and/or 230. Area 804 provides space for asset 242 and/or 244. Various interface buttons 806 provide for navigation, video control, volume control, etc.

At video commencement, the likely first desired asset would be asset 230 as a background, followed by asset 220 as the video portion, although the reverse may also be true. Preferably assets 230 and 220 are displayed simultaneously or almost simultaneously to simulate a uniform video. However, there may be a delay before the second desired asset is displayed. FIG. 8B illustrates environment 800 once it begins displaying both an asset 230 in the form of a picture of a classroom and an asset 220 in the form of an individual speaker. In the alternative, the image that appears in area 802 as asset 220 and 230 could in fact be a single video asset 220, with no separate asset 230.

FIG. 8C illustrates a later point in the timeline where area 804 is populated with asset 242. In this case a first asset 242a is in the form of text. Preferably asset 242 is some text, image and/or video that complements the content of the video presentation at a particular point in time. FIG. 8D illustrates a later point in the timeline where asset 242a transitions to a second asset 242b. This transition could be instantaneous (directly from 242a to 242b) or delayed (a blank display there between as in FIG. 8A).

In an embodiment of the invention, a feedback mechanism may be introduced at some point in the timeline, preferably coinciding with the end of the video presentation of asset 220. A non-limiting example of feedback would be for asset 242 and/or 244 to present fields for the viewer to rate and/or comment on the video. Another non-limiting example would be to present questions consistent with the subject matter of the composite video to measure or confirm that the viewer has absorbed the desired material. This may be particularly desirable for when the composite video is for training purposes. By way of non-limiting example, FIG. 8E presents an asset 244 in the form of an interactive test after the end of the video presented via asset 220. The viewer can select from the answers shown.

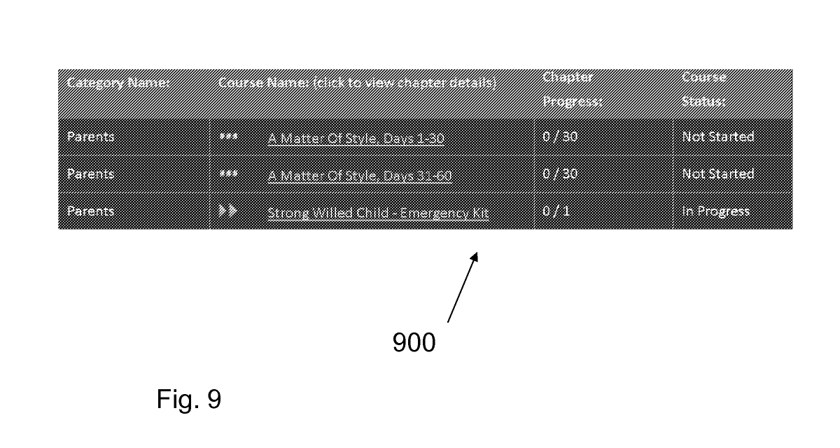

In an embodiment of the invention, the composite video is a self-contained training presentation on a specific topic, or chapters of a topic. When the viewer views the entire self-contained topic, the system will consider that segment completed for record keeping. The system can also monitor which topics have been started or are in progress. This information can be provided via a report available through a web browser, such that an organization can monitor training progress. Statistics can be sortable via an individual or groups of users, dates or other known criteria. FIG. 9 illustrates a portion of a web page showing a sample report 900.

In another embodiment of the invention, the composite video is a self-contained training presentation on a specific topic, or chapters of a topic, and the feedback is a test such as shown in FIG. 8E. If the viewer meets some desired scoring metrics (as may be known in the art), then the viewer will be considered to “pass” the test. This information will be recorded and can be provided via a sortable report similar to FIG. 9.

If the composite video is a chapter or part of multiple chapters, the viewer may optionally be required to get a passing grade on a chapter before being allowed onto the next chapter. If the viewer fails to obtain a passing grade, or even gives a wrong answer to a particular question, the system may transition to a new composite video directed to the error and/or lack of passing grade. For example, a composite video on why the specific answer was incorrect may be presented. The user may then be required to retake the original test, a new test, or some combination thereof. Results are recorded and can be provided via a sortable report similar to FIG. 9.

Certain feedback may be of sufficient significance that, in addition to being recorded, a message is sent directly to a supervising entity for a rapid response. By way of example, a survey that indicates a low mark in customer satisfaction may be so diverted. By way of another example, an answer to a question may be so far off the mark that more direct intervention is necessary.

A non-limiting example of such feedback is the presentation of options for the user to select. The script of the video asset 220 preferably introduces the nature of the text to the viewer, and the text of those options appears as asset 242. Typically the content of the video will refer to those options audibly (“please pick A or B”) and/or visually (hand motions of the speaker pointing in the direction of asset 242). During a timer period at which the options are pending for selection, the video asset 220 may end (by either concluding in a still image of the speaker remaining on the screen, or by having the image fade away).

An optional feature of the invention relates to recording, visually and/or audibly at a pace that is continuous, periodic or aperiodic, while the test taker is taking the test. This allows a reviewer of the test to observe the test environment to confirm that the test taker is both the identified viewer and not someone taking the test for them, and to confirm the absence of outside influence or cheating materials.

Composite video presentations may typically require comprehensive video production services, which may include scripting, acting, recording and editing services. Prior art production of such a video presentation combines the assets to be included to provide a single, common video file that may be presented using a media file player, such as Windows Media Player from Microsoft, Corp. The utilized production services may represent a substantial investment in terms of time and money to complete such a video presentation media file. Accordingly, should any of the assets need to be changed or be desired to be updated—either independently (the contents of one portion) or collectively (the contents of one portion relative to the rest, such as a position change), substantial cost in reproducing the common media file may be involved. In contrast, by generating a composite video at the client-side device using separate files, any individual file can be edited without necessarily requiring edits to the other assets and/or recompiling a common video file.

As discussed in more detail below, options presented (such as by asset 242 or other assets) provide a degree of interaction in the composite video. Based on how the user responds, different assets can subsequently be played. For example, the composite video could provide the user with an option with a detailed explanation of an issue or a summary explanation of an issue. The selection of the detailed explanation would trigger new assets onto the screen, e.g., a new video asset 220 that provides a more detailed explanation, or a new video asset 220 that provides a less detailed explanation. If the user fails to enter any selection, another video asset 220 may play prompting the user to enter a choice.

Preferably, the various assets utilize a synchronization mechanism such that the system presents the assets in the correct sequence. One such method is to provide the assets with time markers relative to the time of the video playback. For example, asset 242a could have a marker to appear at 1:00 of the playback of asset 220, and to disappear at 1:10, while asset 242b could have a marker to appear at 1:30 playback and fade at 1:50. In another embodiment, flags could be incorporated into the video asset 220, the flags containing instructions for when and how contents of other assets are displayed.

In the above embodiments, the assets share a strong correspondence with each other. For example, a particular video asset 220 would have a generally specific asset 242 that contains and presents text that has been specifically tailored to asset 220. While one-to-one correspondence is not necessary, the flexibility of using assets relative to other assets is limited.

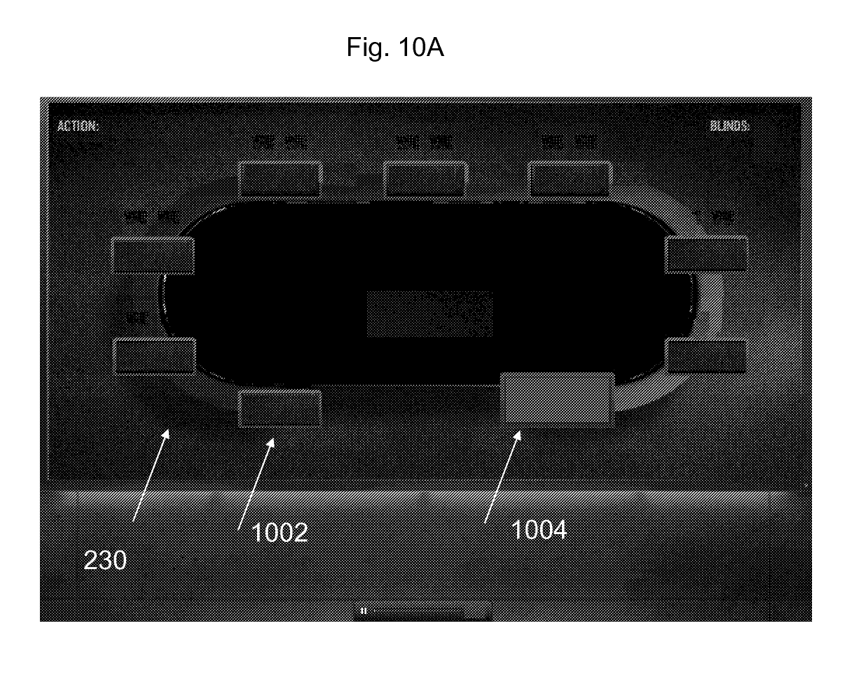

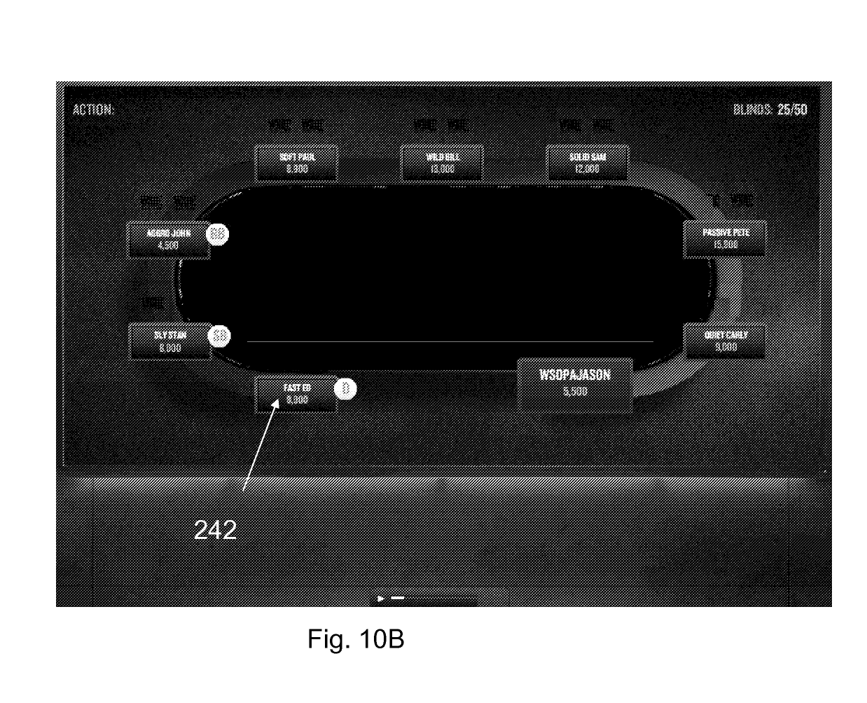

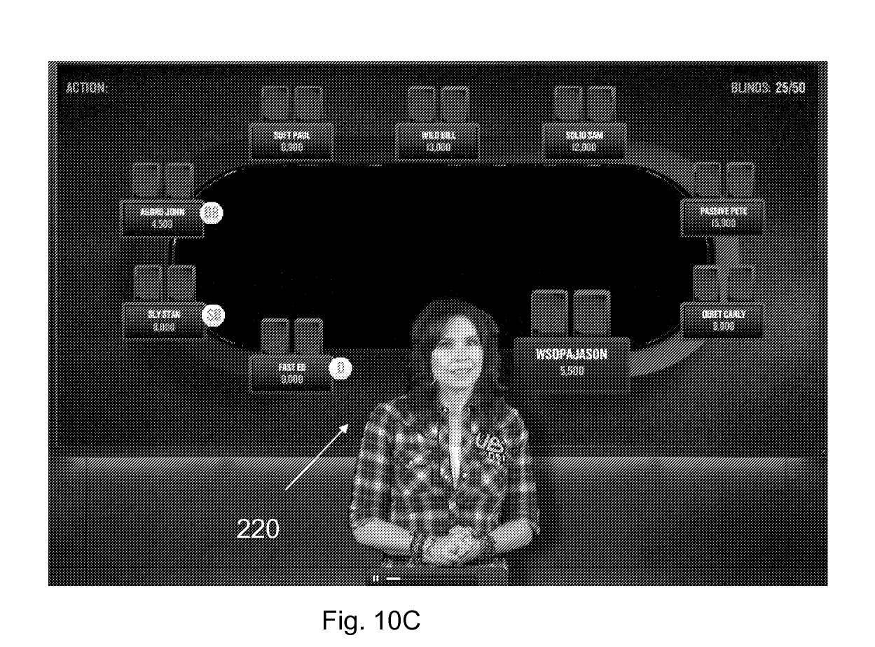

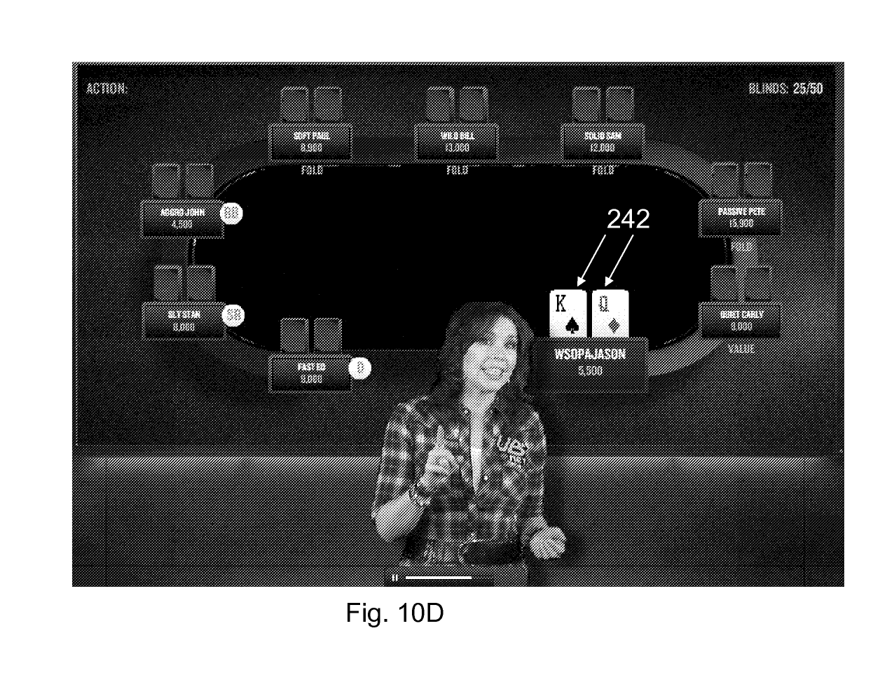

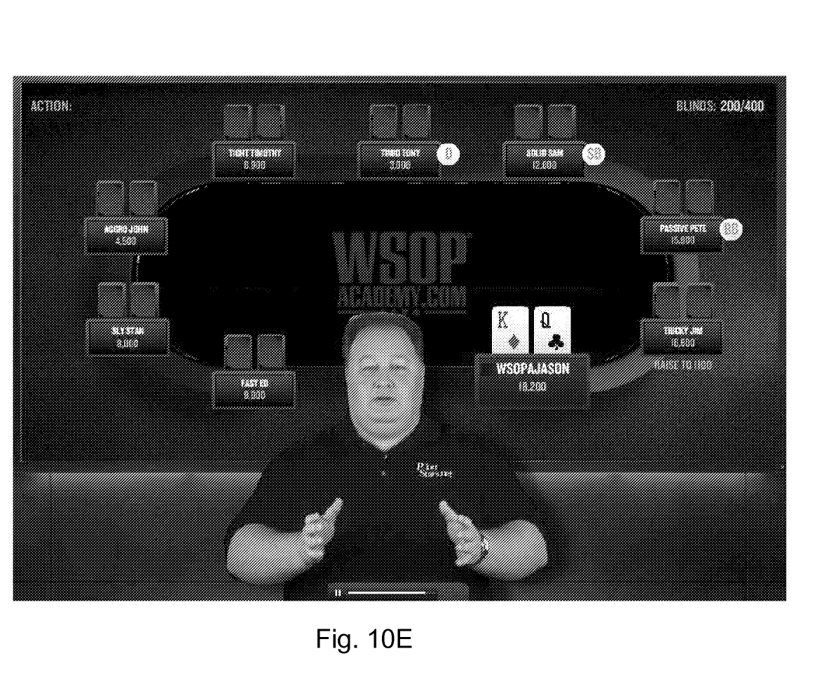

Another embodiment utilizes a combination of video asset 220 with a more generic asset. Referring now to FIGS. 10A-10E, an example is shown in the context of a composite video presentation relating to poker. The assets in play will include a video asset 220 in the form of a presenter, and a background asset 230 in the form of a poker table. Asset 242 will include a set of 52 standard playing cards that can be displayed, as well as graphics for poker related information such as chips, blinds, etc. Instructions 410 (discussed below) will instruct which of assets 242 are to be displayed and where in the composite video.

Referring now to FIG. 10A, asset 230 is shown before population, and includes areas 1002 for information specific to a particular playing position and area 1004 for the user's player position. FIG. 10B shows asset 230 after instructions 410 instruct population of assets 242, in the form of names and chip holdings and blind positions, into the areas for each of the players at areas 1002. Instructions 410 also include chip holdings for user's area 1004, but the name is retrieved as the user's account name. This account name may be part of instruction 410 (as derived from sign in procedures), or taken from the client device.

FIG. 10C shows a composite video after instructions 410 instruct the commencement of video asset 220, a speaker in this case. In this example, video asset 220 is relatively small compared to the viewing area of the composite image. As such, the video is proportionally smaller and can be downloaded quickly to avoid stutter. In addition and/or the alternative, the resolution of video asset 220 can be made higher for a clearer picture.

FIG. 10D shows the composite video after instructions 410 instruct the presentation of two cards, a King and a Queen off suit, as assets 242 at the user's player area. Instructions 410 are set to have these cards appear in synchronization with the portion of the video asset 220 when their appearance is desired. However, a difference between FIG. 10D and FIG. 8C is that, in FIG. 8C, assets 242 would have been designed to provide the King and Queen at the desired time. In the embodiment of FIG. 10D, assets 242 include a library of possibilities and rely upon instructions 410 to select from those possibilities.

This distinction is more evident with further reference to FIG. 10E. In this figure, video asset 220 is a different video relating to a different topic than the video in FIG. 10D. Instructions 410 are set to produce a King and Jack on suit at the user's area 1004. However, the composite video is provided using the same asset 230 and 242 as in FIG. 10D. Thus, where the embodiment in 8A-8E generally requires a new set of assets 230/242/244 for each video 220, the embodiment of FIGS. 10A-10E does not, as it can use the same assets 230/242/244 for any video asset that describes content on the poker table. It should be noted that the game of poker is a non-limiting example of the embodiments, and any types of assets or content could be used.

Instructions 410 may be a separate file or a collection of information (e.g., a database) that is distinct from any of assets 220/230/242/244. In the alternative, instructions 410 could be part of one of those files. For example, the instructions could be embedded into video asset 220 as informational flags or metadata that instruct the other assets how and where to display content in the composite presentation.

The use of separate files for the various assets herein allows for two superior advantages in data downloads. The first is a potential relaxation of delivery requirements. The second is in the order in which files are sent.

With respect to the first advantage, there are typically stringent data delivery requirements associated with effectively displaying video assets (e.g., asset 220). Substantial costs may be involved with providing servers well suited to meet these requirements. For example, third party data delivery solutions, such as those provided by Akamai, may be used. However, the delivery requirements of others of the assets, such as auxiliary assets 242, 244, for example, may not be so stringent. Accordingly, unnecessary resources and/or costs may typically be expended delivering the less resource intensive components of a composite video presentation media file.

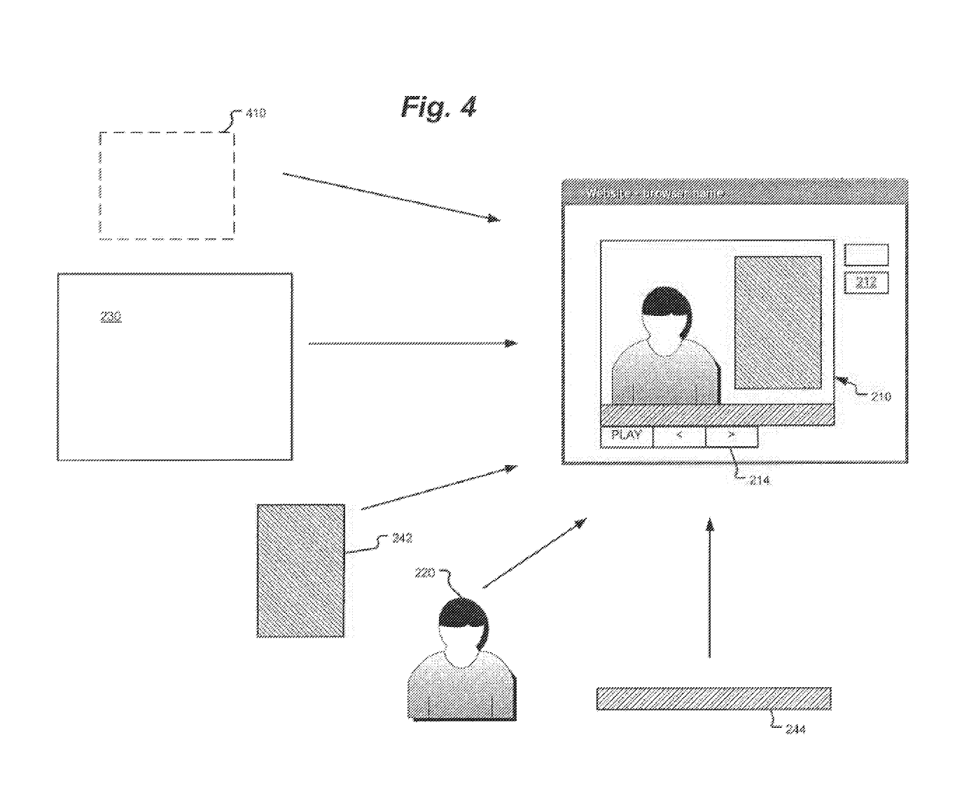

Referring now to FIG. 4, there is shown a block diagrammatic view of a delivery of video presentation 210 according to certain embodiments of the present invention. In certain embodiments of the present invention, at least two assets of a composite video presentation may be delivered separately from one another, as opposed to being integrated into a common media file to be played, for example. In the embodiment of FIG. 4, each of the assets 220, 230, 242 and 244 are separately delivered for combination and playback at a user's computing device (e.g., 110, FIG. 1).

According to certain embodiments of the present invention, instructions for acquiring and assembling the relevant assets into a composite video presentation may also be provided for use at a user's web browser. In certain embodiments of the present invention, such instructions may be provided separate from at least one of the assets. In the embodiment of FIG. 4, instructions 410 are provided separately from each of the assets 220, 230, 242 and 244. In certain embodiments of the present invention, provided instructions may indicate a listing of relevant assets, other information related to the relevant assets (e.g., type of asset, size of asset file), information indicative of a timeline instructing when the relevant assets are to be included in and/or removed from the composite video presentation, and information indicative of an asset mapping showing where in the composite video playback (e.g., where in a playback window) assets are to be used.

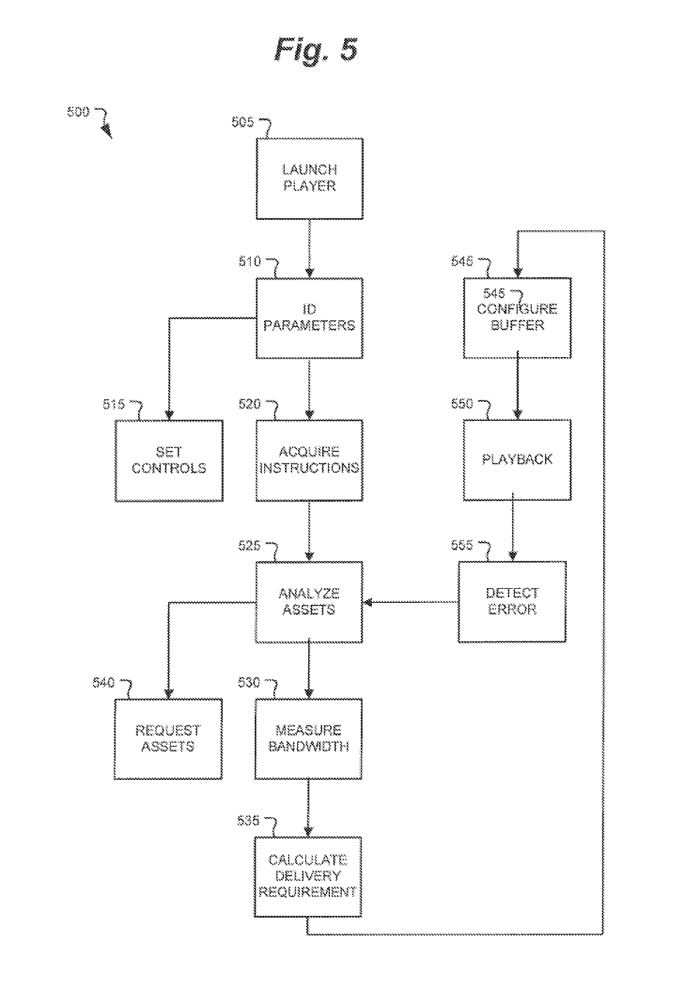

Referring now to FIG. 5, there is shown a block diagrammatic view of a process 500 according to an embodiment of the present invention. Process 500 commences with launching a player application at a user's computing device at block 505. Such an application may take the form of a web browser plug-in, for example. Launching at block 505 may include executing computer executable code stored in memory corresponding to a web browser plug-in for playing a composite video presentation. Launching at block 505 may be commenced upon launching of the corresponding web browser application at the user's computing device, or the loading of a corresponding web page into a corresponding browser at the user's computing device, for example. Launching at block 505 may commence responsively to a user's interaction with a loaded web page using a browser at the user's computing device, for example. By way of further non-limiting example, the player may be launched at block 505 responsively to a user activating a link corresponding to a request to play one or more composite video presentations. By way of further, non-limiting example, the player launched at block 505 may be used to allow a user to commence or progress through one or a series of composite video presentations corresponding to virtual training on a particular topic.

Referring still to FIG. 5, parameters may be identified at block 510. Parameter identification at block 510 may include identifying parameters associated with a user of the user's computing device, such as a user's permissions, for example. Processing at block 510 may include a user providing identification and/or authorization (e.g., user name/password) information. Parameter identification at block 510 may include identifying parameters associated with what composite video presentation should be then played-back. Processing at block 510 may include identifying the composite video presentation that should be then played-back based on a user selection and/or progression along a virtual training program, for example. Parameter identification at block 510 may include identifying user permissions, based upon the user's identity and settings, for example. By way of further non-limiting example, processing at block 510 may include determining whether a user should have the ability to fast forward, rewind or even skip all or a portion of a composite video presentation. Such a control may be particularly useful in a virtual training application, where certain members/users should be permitted to fast-forward through parts or all of a presentation (e.g., trainers), but other users should not (e.g., trainees). Such a control may be particularly useful in a virtual training application, where certain members/users should be permitted to skip through parts or all of a presentation (e.g., users that have already successfully completed a corresponding portion of a virtual training program), but other users shouldn't (e.g., users that have not yet successfully completed a corresponding portion of a virtual training program).

Parameter identification at block 510 may be commenced responsively to a user's interaction with a loaded web page using a browser at the user's computing device, for example. By way of further, non-limiting example, parameters may be identified at block 510 responsively to a user activating a link (e.g., 212, FIG. 4) corresponding to a request to play one or more composite video presentations. By way of further, non-limiting example, parameters may be identified at block 510 based upon a user commencing or progressing through one or a series of composite video presentations corresponding to virtual training on a particular topic, and/or user provided information (e.g., user name/password).

Player playback controls may be set at block 515. According to certain embodiments of the present invention, control elements of a media player launched at block 505 may be set at block 515 consistently with parameters identified at block 510. For example, if a given user is determined not to have the ability to fast-forward through parts of a presentation, then processing at block 515 may include disabling a fast-forward data item, such as a button in the player and/or corresponding host web browsing application that causes a composite video presentation then being played-out to skip forward along a corresponding timeline (e.g., 214, FIG. 4).

Player instructions may be acquired at block 520. According to certain embodiments of the invention, instructions acquired at block 520 may take the form of and/or include instructions for acquiring and assembling relevant assets into a composite video presentation at the user's computing device. According to certain embodiments of the invention, instructions acquired at block 520 may take the form of and/or include instructions analogous to instructions 410 (FIG. 4). According to certain embodiments of the present invention, processing at block 520 may include requesting data, such as a data file, dependently upon parameter identification at block 510. For example, processing at block 510 may identify what composite video presentation is to be played. In such a case, processing at block 520 may include requesting an instruction file corresponding to that composite video presentation. Such a request may be transmitted from a user's computing device 110 to one or more servers 120 (FIG. 1). Processing at block 520 may further include receiving the instructions in the form of data or a data file, from servers 120 (FIG. 1), for example. Processing at block 520 may include parsing the received instructions to identify the assets corresponding to the composite video presentation to be played and a timeline corresponding to their use in the composite video presentation, analogous to that described above, for example.

Assets identified by the instructions acquired at block 520 and the timeline for their use may be analyzed at block 525. Processing at block 525 may include determining the size, number, sources and delivery requirements of the assets at the player, for example.

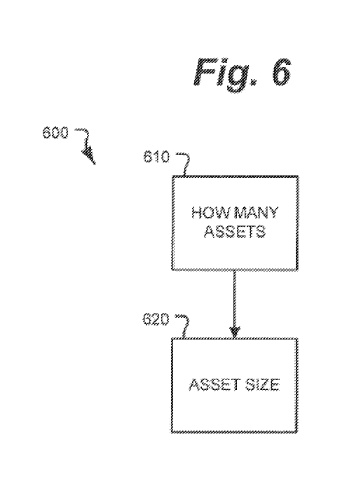

Referring now to FIG. 6, there is shown a block diagrammatic representation of a process 600 according to certain embodiments of the present invention. Process 600 may be suitable for use as at least part of processing at block 520 (FIG. 5). At block 610, the number of assets that are used in the indicated composite video presentation may be determined, such as by considering the instructions acquired at block 520. At block 620, data amount (e.g., asset file size, and/or the playback duration) and/or delivery need (e.g., the time in the timeline when some or all of the asset data will be needed for composition) may be determined. Processing at block 620 may consider the asset and timeline information included in the instructions acquired at block 520.

Referring again to FIG. 5, the communications bandwidth available for asset delivery may be determined at block 530. In certain embodiments of the present invention, the communications bandwidth for asset delivery may be determined by determining or considering the communications bandwidth or speed available for use by the user's computer and available to the host browser application and/or instantiated player, for example.

Delivery requirements for the assets based upon the measured bandwidth availability may be determined at block 535. In certain embodiments of the present invention, it may be determined that all necessary assets must be delivered to the player buffer prior to commencing playback. In certain embodiments of the present invention, it may be determined that a given percentage of one or more of the assets be delivered to the player buffer prior to commencing playback. In certain embodiments of the present invention, adaptive buffering that considers asset parameters, delivery constraints and proposed usage in the corresponding timeline may be used to determine a given percentage of one or more of the assets to be delivered to the player buffer prior to commencing playback.

Referring still to FIG. 5, the relevant assets may be requested at block 540. In certain embodiments of the present invention, one or more of the assets identified at block 520 may be requested at block 540. For example, where one or more of the assets are identified as being deliverable by one or more of the servers 120 (FIG. 1) to the user's computer 110 (FIG. 1), request(s) for delivery of relevant data, e.g., asset files, may be sent from requesting computing device(s) 110 via network 130 to one or more of servers 120 at block 540. Server(s) 120 may respond by providing the requested assets via network 130 to the requesting computing device(s) 110.

One or more receive buffers included in, associated with and/or accessible by the launched player application may be initialized, configured and/or operated at block 545. Processing at block 545 may include configuring a buffer in accordance with the delivery requirements calculated at block 535.

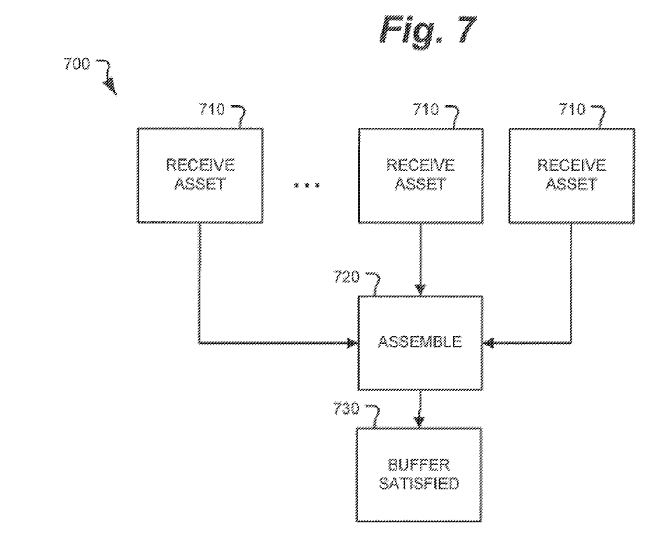

Referring now also to FIG. 7, there is shown a block diagrammatic view of a process 700 according to certain embodiments of the present invention. At block 710, assets are received at the player buffer in accordance with the requests made at block 540. The received assets are assembled at block 720 into a composite video production at the player in accordance with the instructions acquired at block 520. Once the buffer(s) is/are determined to be sufficiently full at block 730 in accordance with the processing described above, processing returns to FIG. 5.

Referring again to FIG. 5, according to certain embodiments of the present invention, data received that satisfies the requests provided at block 540 may be provided to buffer(s), and the assembled composite video presentation read-out therefrom for playback by the player, in accordance with the configuration at block 545, at block 550.

Should an error in data delivery for playback (e.g., buffer loading, read-out and/or playback) be detected at block 555, processing may return to block 525, such that processing continues as discussed above, with regard to assets and/or portions of assets that have not yet been delivered to the buffer, for example.

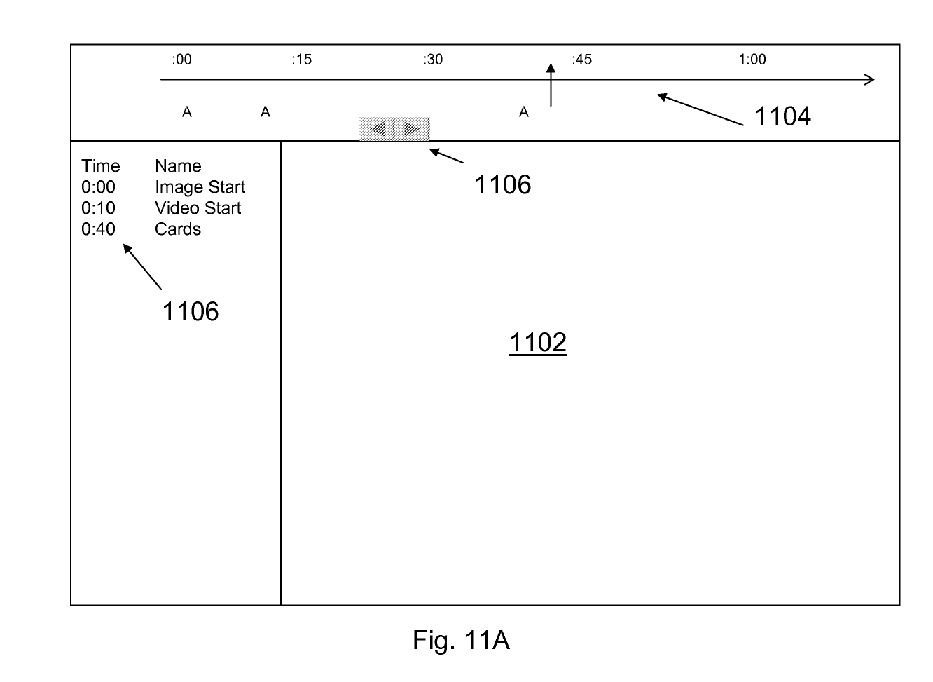

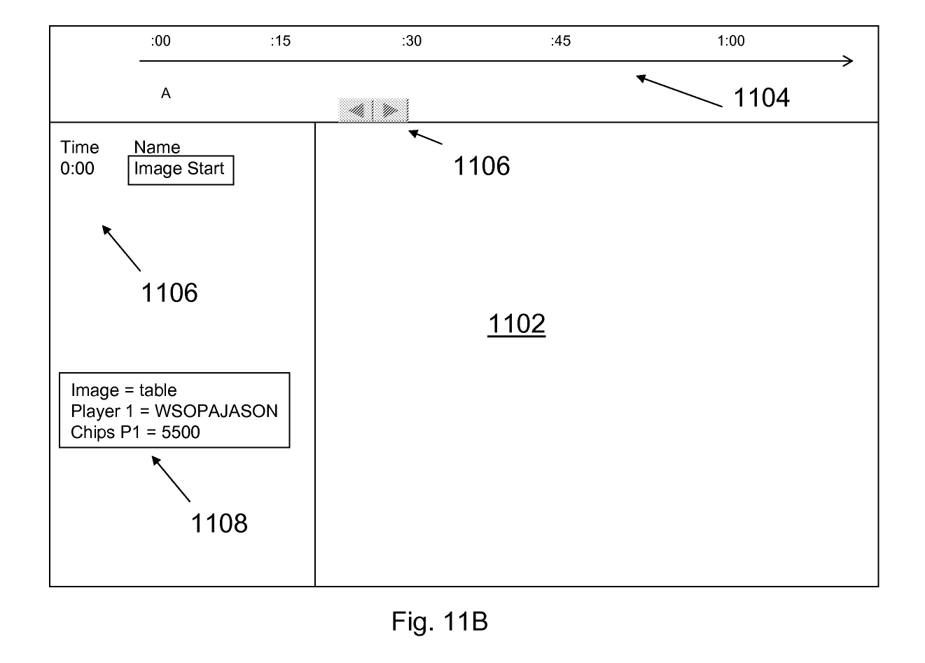

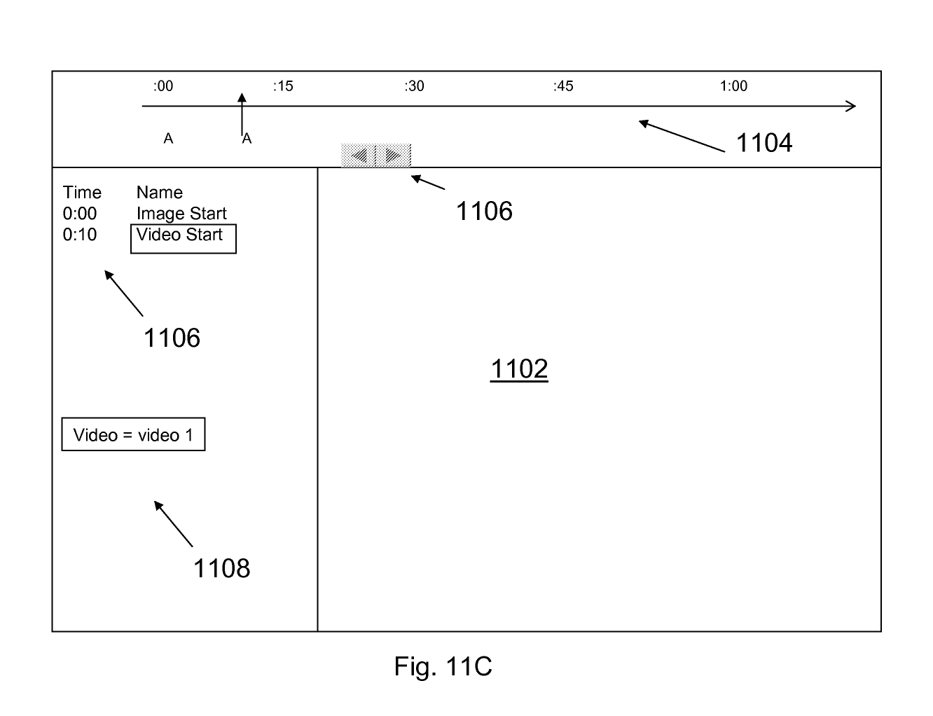

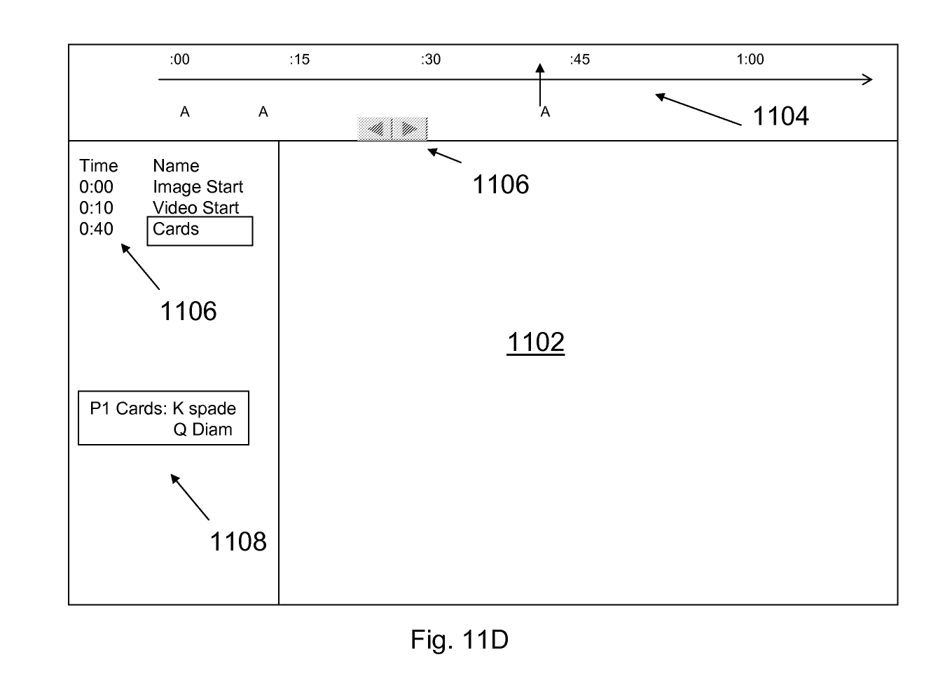

Referring now to FIGS. 11A-11D, another embodiment of the invention involves a creation tool for the composite presentation. In this embodiment, the creator already has access to the various assets and needs to create the instructions 410 that will ultimately be used. A graphic user interface (GUI) of the tool presents an environment in which the user can create the instructions 410 for manipulation and/or creation of assets.

Referring now to FIG. 11A, a basic GUI 1100 of the creation tool is shown. The GUI 1100 includes a display area 1102 for displaying various assets, typically video asset 220 (as this tends to be the foundational asset which other assets are synchronized to). A timeline 1104 provides a timeline of the display of the various assets. Virtual fields 1106 provide access to the elements of the creation tool. Typical time line controls (play, pause, etc.) 1108 control playing of the assets in real time.

For ease of discussion, and by way of non-limiting example, the use of the creation tool in FIGS. 11A-D will be discussed with respect to the composite video as shown in FIGS. 10A-10D. However, the invention is not so limited.

Referring now to FIG. 11B, the creator wants the composite video to begin with the poker table as the background asset 230, and to have the various fields (name, position, blinds, chips) populate from asset 242. Accordingly, the creator places the time marker 1110 of the time bar on the desired point (in this case time t=0), and enters an Action flag “A”. A field is created at 1106. Clicking on the field opens a sub-window 1110 that the user can populate with instructions.

The user then populates the fields as appropriate. FIG. 11B shows population of the fields for the background asset 230 (black poker table), the name of the first player (in this case the user id to be ascertained from login information) and first chip amount A. When the fields are partially or fully populated, the user can save the changes. The information as populated in the fields ultimately forms part of the instructions 410. If the composite video was played at this point, the image would appear in display area 1102 as shown in FIG. 10C. (For ease of readability, FIG. 11B does not show the other fields, although it is to be understood that in practice the number and/or size of the fields would be desired for the needs of the system).

Fields 1108 may be populated by typing information into the fields. However, the invention is not so limited. The fields may be populated via a drop down menu which the available selection, or hybrid of drop down menu and direct entry. The invention is not limited to a particular method of populating the fields.

Once the instructions are entered, based on user preferences, the creation tool may or may not display the composite video based on what has been programmed into instructions 410. For example, the user could instruct the creation tool to display the results of the instructions set for after time t=0, or the user could instruct the creation tool not to display it. This ultimately reflects the preference of the user as to the environment they are most comfortable with. For ease of reference, discussion will proceed as if the user had elected to not display the information as just entered.

Referring now to FIG. 11C, the creator wants the video to begin playback at time t=10. The user moves the time marker to that point, opens the field, and identifies the video to play. These commands form new instructions to enter into instructions 410.

Preferably, as noted in FIG. 11D, the creation tool will show the video during the times t=10 through t-40 during which the video is programmed to play, as the video is itself is typically the reference against which other assets are synchronized. Thus, for example, when the video reaches the point at which it would be appropriate to deal the King and the Queen in FIG. 10D (in this case at t=40). Preferably, the instructions 410 will be set so that the desired cards appear at the poker table, then the video is frozen at that point and the instructions for those cards are placed at the corresponding time marker on the timeline. Instructions 410 will subsequently contain the information to bring up those cards during the video at the programmed time.

As discussed above, instructions 410 may be in a separate file or in a database of information from other assets. In the alternative, instructions 410 may be embedded into the video asset 220, such as in the form of meta data to a Flash video file. CAPTIONATE is an appropriate software tool for this purpose. Other software tools and/or formats could also be used.

The methodology discussed with respect to FIGS. 10 and 11 provides a greater degree of customization with respect to the overall composite video relative to the methodology discussed with respect to FIG. 8. As discussed above with respect to FIG. 8A, various assets (e.g., asset 242) are fairly unique to each video asset 220, such that different videos require the creation of different assets. This can increase the time needed to create and/or modify the videos or the assets. In contrast, the methodology of FIGS. 10 and 11 have generic assets that operate as dictated by the instructions 410, which allows the same assets to be used for different videos. For example, FIGS. 10A-10C reflect a video for high off suit cards. A different video asset can be directed to low off suit cards, yet the same asset 242 (the full deck of 52 cards) can be used as required by instructions 410.

In an alternative embodiment, the full scope of assets 242 may be available at the distribution source, typically a server. Rather than downloading the enter asset 242, only the portions of asset needed by instructions 410 are pulled from the library and sent for use in the composite video. This provides the same level of customization but with reduced download requirements.

Another embodiment of the invention relates to the download of the various assets before commencement of the video. Preferably the video should not commence until (a) all non-video assets have downloaded and (b) enough of the video assets have downloaded that the video assets can be played in real-time without stutter. With respect to (a), full download of the non-video assets is preferable because the viewer may unpredictably fast forward to different points in the video. This, in and of itself, can create a lag or stutter while the video buffers up that later portion of the video. But there will be no delay in the non-video elements being instantly available when the new video portion is played. With respect to (b), when the user interaction prompts one or more videos, the video is loaded into the video player.

Once loading has begun, the player measures the user's download rate, preferably in bytes per second. The video player then determines how many seconds it will take to load the entire file. The duration of the video is subtracted from this number and the video clip is buffered for the remainder.

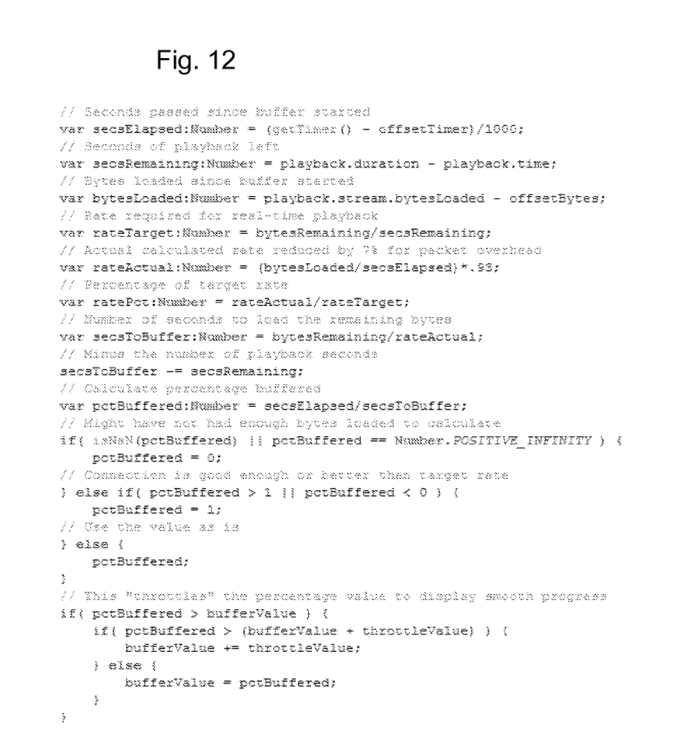

The non-video assets (preferably in a single swf file) download concurrently. A preloaded graphic displays a progress value of 0-100% that is a combination of the assets' progress and the video's buffer. The ratio of the impact of the non-video assets compared with video assets is 20/80, although other levels of distribution may be used. When this combined value reaches 100%, video playback begins. A download using this methodology can play the entire video in real time without stutter so long as there is no significant change in download speed. FIG. 12 shows a non-limiting example of software code that can execute these instructions.

It will be apparent to those skilled in the art that modifications and variations may be made in the systems and methods of the present invention without departing from the spirit or scope of the invention. It is intended that the present invention cover the modifications and variations of this invention provided they come within the scope of the appended claims and their equivalents.

What is claimed is:

1. A method of receiving and playing a composite video, wherein the composite video includes at least a video asset and a non-video asset in separate files, the method comprising:
receiving the non-video asset;
receiving at least a portion of the video asset;
buffering the at least a portion of the video asset in a buffer;
delaying playback of the composite video until (a) the non-video asset is downloaded and (b) the at least a portion of the video asset received is sufficient under existing conditions that the video asset can be played in real time without emptying the buffer before the end of the video asset; and
playing, after the delaying, the composite video.

2. The method of claim 1, further comprising:
displaying, during the delaying playback, a download progress bar, the progress bar representing the following equation:
Progress=(x·amount of non-video asset download)+(y·amount start video asset downloaded)
where:
x and y are predetermined values for which x+y=100%; and
“start video asset” is a portion of the video asset that, under existing conditions, needs to be downloaded before the video asset can be played in real time without emptying the buffer before the end of the video asset.

3. The method of claim 2, where x is 20% and y is 80%.

4. The method of claim 1, wherein the existing conditions include at least the download rate, the length of the video asset, and the amount of time it will take to download the entire video asset.

5. The method of claim 1, wherein the video and non-video assets are synchronized, and the composite video include portions of the non-video asset displayed during discrete portions of playback of the video asset.

6. The method of claim 1, further comprising receiving instructions for when to play discrete portions of the non-video asset relative to the video asset.

7. The method of claim 6, wherein the instructions are part of the same file as the video asset.

8. The method of claim 1, wherein the non-video asset includes an image of a background on which the video asset will be displayed.

9. The method of claim 1, wherein the non-video asset includes text that will appear during a predetermined portion of the playing of the video asset.

10. The method of claim 1, wherein the non-video asset includes at least one test question, the method further comprising displaying the test question after playback of the video asset ends.

11. A method of playing a composite video, the method comprising:
downloading a non-video asset file, the non-video asset file including a library of non-video assets;
receiving a video;
buffering the video;
receiving instructions that (a) select the non-video asset from the library, (b) identify where in a display the non-video asset is to be displayed, and (c) when, relative to the video, the non-video asset is to be displayed;
playing the video and the selected non-video assets from the library, synchronized according to the instructions.

12. The method of claim 11, wherein the playing commences when the non-video asset file is downloaded and a sufficient portion of the video has been buffered such that the video can be played in real time in its entirety.

13. The method of claim 11, wherein the video and the instructions are part of a common file.

14. The method of claim 11, wherein the video is in a file different from the non-video asset file.

15. The method of claim 11, wherein the non-video asset includes an image of a background on which the video will be displayed.

16. The method of claim 11, wherein the non-video asset includes at least one test question, the method further comprising displaying the test question after playback of the video ends.

17. The method of claim 11, further comprising displaying a download progress bar, the bar representing a combination of (a) a portion of the non-video asset downloaded and (b) a portion of the video asset buffered relative to the minimum amount of the video needed to be buffered so that the video can play in its entirety in real time.

18. The method of claim 11, further comprising delaying the playing until (a) the entire non-video asset is downloaded and (b) the part of the entire video asset received is sufficient under existing conditions that the video asset can be played in real time without emptying the buffer before the end of the video asset.
